(19) United States
(12) Patent Application Publication
(10) Pub. No.: US 2024/0231875 A1
(43) Pub. Date: Jul. 11, 2024

(54) METHOD OF DEPLOYING AN AGENT PLATFORM THAT ENABLES CLOUD-BASED MANAGEMENT OF MANAGEMENT APPLIANCES

(71) Applicant: VMWARE, INC., Palo Alto, CA (US)

(72) Inventors: PRAVEEN TIRUMANYAM, Bangalore (IN); Sreetam Parida, Bangalore (IN); Avinash Venkatesh Bhat, Bangalore (IN); Vijay Thimmanahalli Krishnamurthy, Bangalore (IN)

(21) Appl. No.: 18/120,471

(22) Filed: Mar. 13, 2023

(30) Foreign Application Priority Data
Jan. 7, 2023 (IN) 202341001423

(51) Int. Cl. G06F 9/455

(52) U.S. Cl. CPC G06F 9/45558; G06F 2009/45591; G06F 2009/45595

(57) ABSTRACT

A method of deploying an agent platform on an agent platform appliance, wherein the agent platform connects management appliances to cloud services executing on a cloud platform, includes the steps of: initiating a sequence of steps to deploy the agent platform on the agent platform appliance; executing the sequence of steps up to a particular checkpoint, and continuing execution of the sequence of steps beyond the particular checkpoint; during the continued execution of the sequence of steps beyond the particular checkpoint, detecting an error; determining that the detected error is a recoverable error; and in response to the determining that the detected error is a recoverable error, resuming execution of the sequence of steps from the particular checkpoint.

### RELATED APPLICATIONS

Benefit is claimed under 35 U.S.C. 119(a)-(d) to Foreign Application Serial No. 202341001423 filed in India entitled “METHOD OF DEPLOYING AN AGENT PLATFORM THAT ENABLES CLOUD-BASED MANAGEMENT OF MANAGEMENT APPLIANCES”, on Jan. 7, 2023, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host servers, storage devices, and networking devices. The provisioning of the virtual infrastructure is carried out by SDDC management software that is deployed on management appliances, such as a VMware vCenter Server® appliance and a VMware NSX® appliance, available from VMware, Inc. The SDDC management software manages the virtual infrastructure by communicating with virtualization software (e.g., a hypervisor) installed in the host servers.

It has become common for multiple SDDCs to be deployed across multiple clusters of host servers. Each cluster is a group of host servers that are managed together by the management software to provide cluster-level functions, such as load balancing across the cluster through VM migration between the host servers, distributed power management, dynamic VM placement according to affinity and anti-affinity rules, and high availability (HA). The management software also manages a shared storage device to provision storage resources for the cluster from the shared storage device, and manages a software-defined network through which the VMs communicate with each other.

For some customers, their SDDCs are deployed across different geographical regions and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that the SDDCs of a particular organization are provisioned in a public data center along with SDDCs of other organizations. “SDDCs deployed as a service” means that the SDDCs are provided to the organization as a service on a subscription basis. As a result, for SDDCs deployed as a service, the organization does not need to carry out management operations on the SDDCs such as configuring, upgrading, and patching, and the availability of the SDDCs is provided according to a service-level agreement (SLA) of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services,” are delivered to SDDCs. The cloud services are delivered through agents of the cloud services that are running in an appliance, referred to herein as an “agent platform (AP) appliance.” The cloud platform is a computing platform that hosts containers or VMs corresponding to the cloud services delivered from the cloud platform. The AP appliance is deployed in the same customer environment, e.g., a private data center, as management appliances of the SDDCs.

Embodiments are depicted herein in a hybrid environment because the cloud platform is provisioned in a public cloud, and the AP appliance and the SDDCs are provisioned in the customer environment. Because the cloud platform and the AP appliance are in different computing environments, the two communicate over a public network such as the Internet. On the other hand, the AP appliance and the management appliances of the SDDCs communicate with each other over a private physical network, e.g., a local area network (LAN). Examples of cloud services that are delivered include an SDDC configuration service, an SDDC upgrade service, an SDDC monitoring service, an SDDC inventory service, and a message broker service. Each of these cloud services has a corresponding agent installed on the AP appliance. All communication between the cloud services and the management software of the SDDCs is carried out through the AP appliance, for example, through agents of the cloud services installed on the AP appliance.

Embodiments provide a method of deploying an agent platform on an agent platform appliance, wherein the agent platform connects management appliances to cloud services executing on a cloud platform. The method includes the steps of: initiating a sequence of steps to deploy the agent platform on the agent platform appliance; executing the sequence of steps up to a particular checkpoint, and continuing execution of the sequence of steps beyond the particular checkpoint; during the continued execution of the sequence of steps beyond the particular checkpoint, detecting an error; determining that the detected error is a recoverable error; and in response to the determining that the detected error is a recoverable error, resuming execution of the sequence of steps from the particular checkpoint.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of customer environments of different organizations that are managed through a multi-tenant cloud platform implemented in a public cloud.

FIG. 2 is a block diagram of a single customer environment and the public cloud, illustrating the downloading of AP appliance bits for installation in the customer environment.

FIG. 3 is a block diagram of a status bar that tracks the deployment of an AP on an AP appliance, including checkpoints of the deployment.

FIG. 4 is a block diagram of the customer environment and the public cloud, illustrating execution of steps to reach a first checkpoint of the deployment, which is verifying that the AP appliance is able to communicate with the cloud platform with a latency that is below a threshold.

FIG. 5 is a block diagram of the customer environment and the public cloud, illustrating execution of steps to reach a second checkpoint of the deployment, which is creating an authentication account to be used for acquiring access tokens for authenticating with cloud services.

FIGS. 6A-6C are a sequence of block diagrams of the customer environment and the public cloud, illustrating execution of steps to reach a third checkpoint of the deployment, which is registering the AP appliance with the cloud platform to enable the AP appliance to acquire the access tokens via the authentication account.

FIGS. 7A-7D are a sequence of block diagrams of the customer environment and the public cloud, illustrating execution of steps to reach a fourth checkpoint of the deployment, which is downloading agents to be installed on the AP appliance.

FIG. 8 is a block diagram of the customer environment and the public cloud, illustrating execution of steps to complete the deployment of the AP on the AP appliance.

FIG. 9 is a flow diagram of a method performed by an installer service to execute a sequence of steps to deploy the AP on the AP appliance, according to an embodiment.

FIG. 10 is a flow diagram of a method performed by the installer service upon encountering a recoverable error, to resume execution of the sequence of steps from a previous checkpoint that was reached.

FIG. 11 is a flow diagram of a method performed by the installer service to resolve an issue that caused a recoverable error.

### DETAILED DESCRIPTION

Techniques for deploying an AP on an AP appliance are described, wherein the AP appliance, once deployed, enables cloud-based management of management appliances of an SDDC. AP appliance bits are first downloaded from a product repository for installing the AP on the AP appliance. Then, according to the techniques, a sequence of steps are executed to deploy the AP, the sequence of steps being divided into checkpoints. When an error in the deployment is encountered, an installer service determines whether the error is a “recoverable error” or a “nonrecoverable error.” As used herein, a recoverable error is an error that does not require restarting the deployment of the AP. A nonrecoverable error, however, requires restarting the deployment of the AP.

Therefore, if an error is recoverable, the deployment of the AP is resumed from a previous checkpoint. This saves considerable time in comparison to restarting the deployment from the beginning, especially if the deployment is almost complete. Furthermore, even if the error is nonrecoverable, although the deployment is restarted, the state of the AP is restored from the initial point at which the AP was installed from the AP appliance bits. Accordingly, the AP appliance bits are not redownloaded and reinstalled, which also saves time. These and further aspects of the invention are discussed below with respect to the drawings.

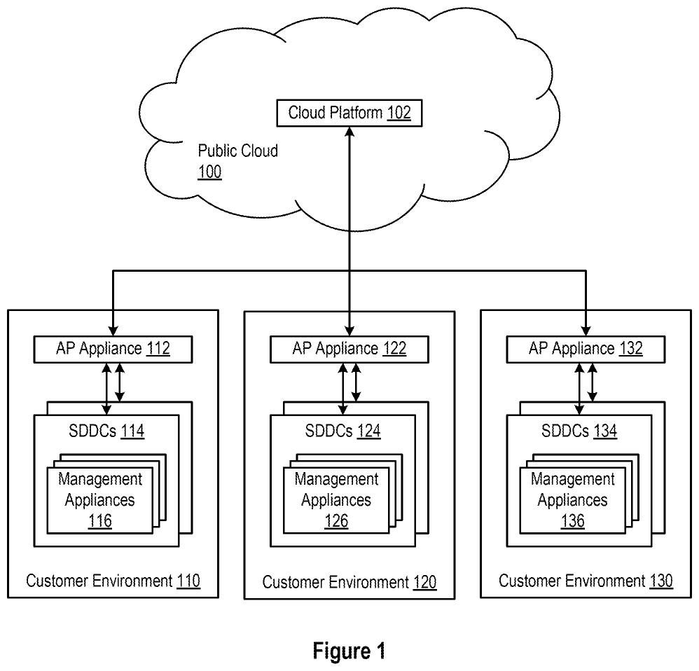

FIG. 1 is a block diagram of customer environments 110, 120, and 130 of different organizations (hereinafter also referred to as “customers”). The customer environments are managed through a multi-tenant cloud platform 102 implemented in a public cloud 100. A plurality of SDDCs is illustrated in each of the customer environments, including SDDCs 114 in customer environment 110, SDDCs 124 in customer environment 120, and SDDCs 134 in customer environment 130. As used herein, a “customer environment” means one or more private data centers managed by the customer, which is commonly referred to as “on-premise,” a private cloud managed by the customer, a public cloud managed for the customer by another organization, or any combination of these. In addition, the SDDCs of any one customer may be deployed in a hybrid manner, e.g., on-premise, in a public cloud, and/or as a service, and across different geographical regions.

In each customer environment, the SDDCs are managed by respective management appliances, including management appliances 116 of SDDCs 114, management appliances 126 of SDDCs 124, and management appliances 136 of SDDCs 134. The management appliances of each of the customer environments include a virtual infrastructure management (VIM) server (e.g., a VMware vCenter Server® appliance, available from VMware, Inc.) for overall management of virtual infrastructure of respective SDDCs. The management appliances of each of the customer environments further include a network management server (e.g., a VMware NSX® appliance, available from VMware, Inc.) for management of virtual networks of respective SDDCs.

The management appliances in each of the customer environments communicate with a respective AP appliance, including an AP appliance 112 in customer environment 110, an AP appliance 122 in customer environment 120, and an AP appliance 132 in customer environment 130. Agents (not shown in FIG. 1) are installed on each of the AP appliances, and the agents communicate with cloud platform 102 to deliver cloud services to respective customer environments. In some embodiments, each of the AP appliances and each of the management appliances are a virtual appliance. A virtual appliance is a software solution that includes an application and OS and that is preconfigured, i.e., that does not require manual configuration upon delivery. In other embodiments, any of the AP appliances and the management appliances may be hardware-based appliances implemented as physical host servers. APs have already been deployed on the AP appliances illustrated in FIG. 1. The deployment of APs on AP appliances will be discussed below.

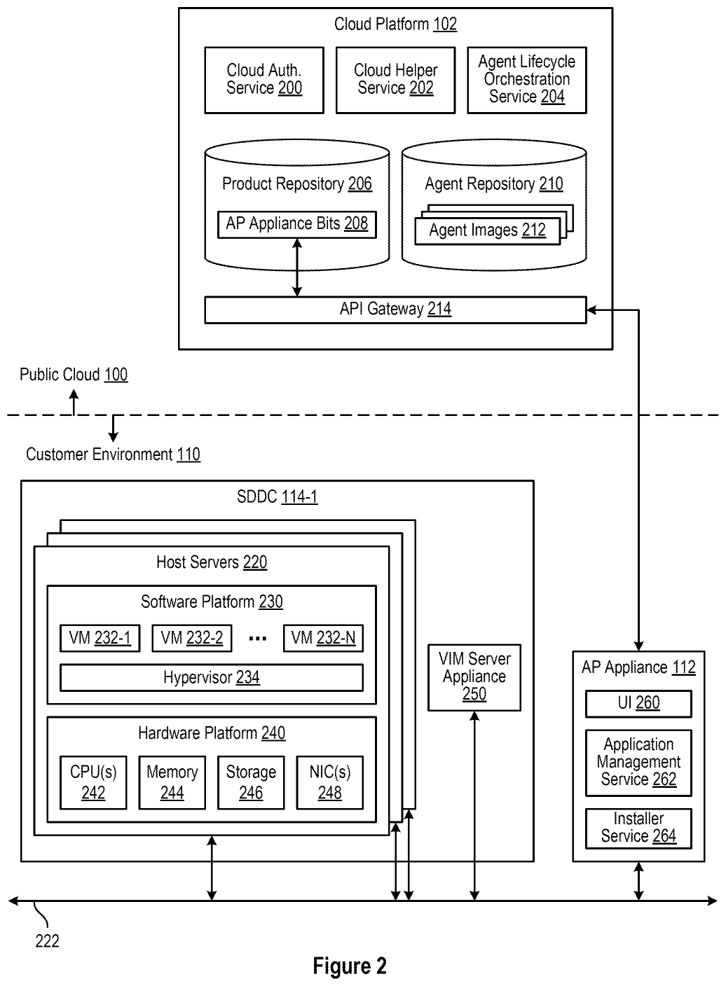

FIG. 2 is a block diagram of customer environment 110 and public cloud 100, illustrating the downloading of AP appliance bits 208 for installation in customer environment 110. Customer environment 110 includes an SDDC 114-1, which includes a plurality of host servers 220 and a VIM server appliance 250. Each of host servers 220 is constructed on a server grade hardware platform 240 such as an x86 architecture platform.

Hardware platform 240 includes conventional components of a computing device, such as one or more central processing units (CPUs) 242, memory 244 such as random-access memory (RAM), storage 246 such as one or more magnetic drives or solid-state drives (SSDs) and/or a host bus adapter for connecting to a storage area network, and one or more network interface cards (NICs) 248. NIC(s) 248 enable host servers 220 to communicate with each other and with other devices over a physical network 222. Physical network 222 is distinguishable from a public network such as the Internet through which cloud platform 102 communicates with devices of customer environment 110. Physical network 222 is a private network, e.g., a LAN or a sub-net, and is partitioned from the public network through a firewall.

Hardware platform 240 of each of host servers 220 supports a software platform 230. Software platform 230 includes a hypervisor 234, which is a virtualization software layer. Hypervisor 234 supports a VM execution space within which VMs 232 are concurrently instantiated and executed. One example of hypervisor 234 is a VMware ESX® hypervisor, available from VMware, Inc. VIM server appliance 250 logically groups host servers 220 into a cluster to perform cluster-level tasks such as provisioning and managing VMs 232 and migrating VMs 232 from one of host servers 220 to another. VIM server appliance 250 communicates with host servers 220 via a management network (not shown) provisioned from physical network 222. VIM server appliance 250 may be, e.g., a physical server or one of VMs 232.

Public cloud 100 is operated by a cloud computing service provider from a plurality of physical host severs (not shown). Cloud platform 102 includes cloud services such as a cloud authentication service 200, a cloud helper service 202, an agent lifecycle orchestration service 204, and other cloud services (not shown). Such other cloud services include an SDDC configuration service, an SDDC upgrade service, an SDDC monitoring service, an SDDC inventory service, and a message broker service. In one embodiment, each of the cloud services of cloud platform 102 is a microservice that is implemented as one or more container images executed on a virtual infrastructure of public cloud 100. Devices of customer environment 110 communicate with the cloud services by making API calls such as Java API calls via an API gateway 214.

Cloud helper service 202 performs operations to establish trust with AP appliances, as discussed further below. Agent lifecycle orchestration service 204 maintains desired states (not shown) to share with the AP appliances. Such desired states include lists of agents to install on the AP appliances. Cloud authentication service 200 enables authentication with cloud helper service 202, agent lifecycle orchestration service 204, and the other cloud services. To enable such authentication, cloud authentication service 200 issues access tokens such as JavaScript Object Notation (JSON) web tokens (JWTs). Each access token allows a requesting party to communicate with a cloud service via API gateway 214. It should be noted that although cloud authentication service 200 is illustrated as being within cloud platform 102, cloud authentication service 200 may run on a virtual or physical server that is not part of cloud platform 102 but that is still accessible to cloud platform 102. For security purposes, access tokens each have a specified time-to-live (TTL) after which the tokens expire.

Cloud platform 102 includes a product repository 206 and an agent repository 210. Product repository 206 stores bits for software that may be installed in customer environments, including AP appliance bits 208. For example, AP appliance bits 208 may be stored as an ISO file. Agent repository 210 stores images of agents to be installed on AP appliances such as Docker® container images. When one of host servers 220 triggers the installation of an AP appliance, host server 220 transmits a request to product repository 206 via API gateway 214 for AP appliance bits 208. For example, an administrator of an organization may trigger the installation. Upon receiving the request, product repository 206 transmits AP appliance bits 208 to host server 220 for installation thereon of AP appliance 112.

AP appliance bits 208 include code for executing a user interface (UI) 260 through which the administrator interacts with AP appliance 112. AP appliance bits 208 further include code for executing various services that are used throughout the deployment of an AP on AP appliance 112. Accordingly, upon installation of AP appliance 112 from AP appliance bits 208, AP appliance 112 includes UI 260, an application management service 262, and an installer service 264. For example, these services may be packaged within AP appliance bits 208 as RPM files. The functionalities of these services are discussed further below.

It should be noted that AP appliance bits 208 also include code for executing other services, including an envoy proxy service and a watchdog service (not shown in FIG. 2). However, such services are installed later during the deployment of the AP, as discussed further below. In embodiments described herein, AP appliance 112 is one of VMs 232. However, in other embodiments, AP appliance 112 may be implemented as a physical host server such as one of host servers 220 or may be implemented via other types of virtual computing instances such as containers, Docker® containers, data compute nodes, and isolated user space instances.

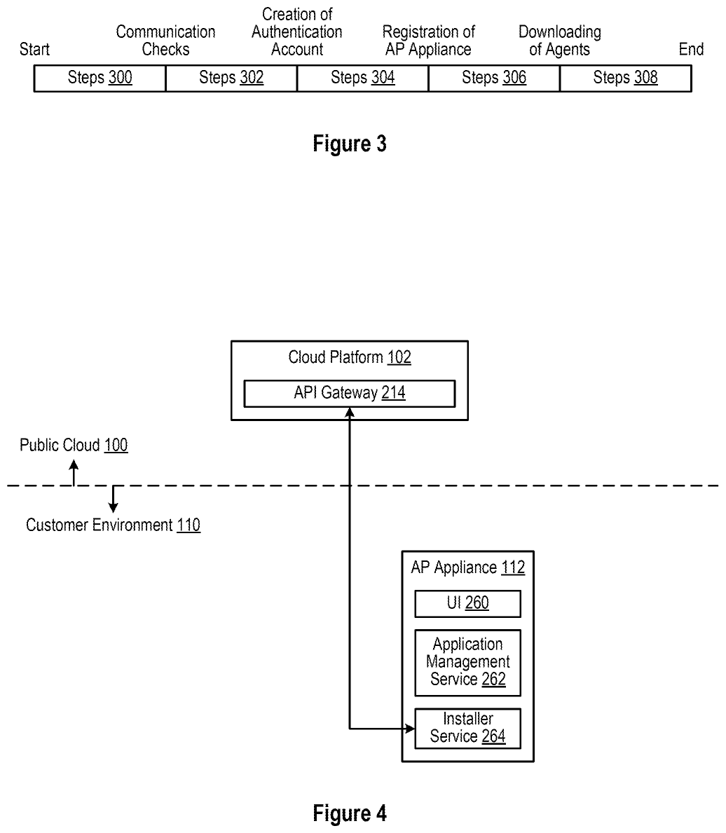

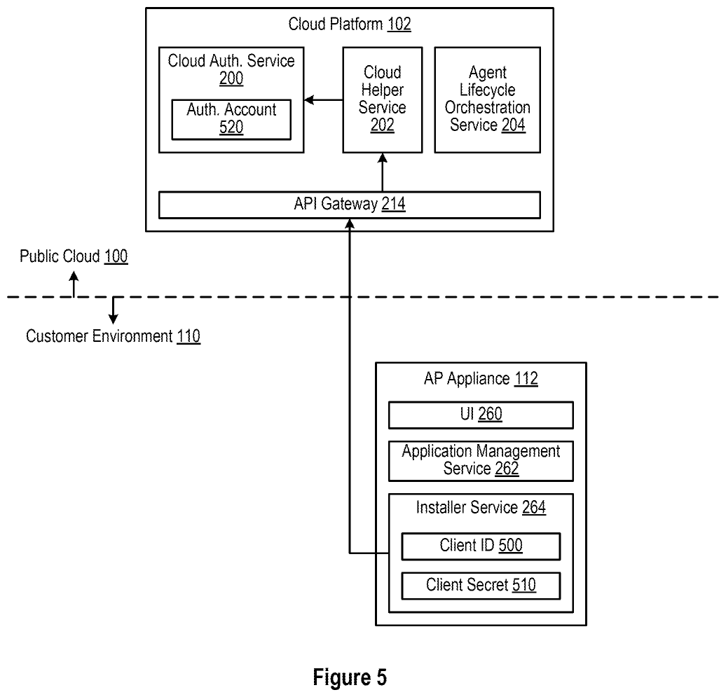

FIG. 3 is a block diagram of a status bar that tracks the deployment of the AP on AP appliance 112, including checkpoints of the deployment. At the start, installer service 264 executes steps 300 for deploying the AP before reaching a first checkpoint, “Communication Checks.” Steps 300 are discussed further below in conjunction with FIG. 4. Next, installer service 264 executes steps 302 for deploying the AP before reaching a second checkpoint, “Creation of Authentication Account.” Steps 302 are discussed further below in conjunction with FIG. 5.

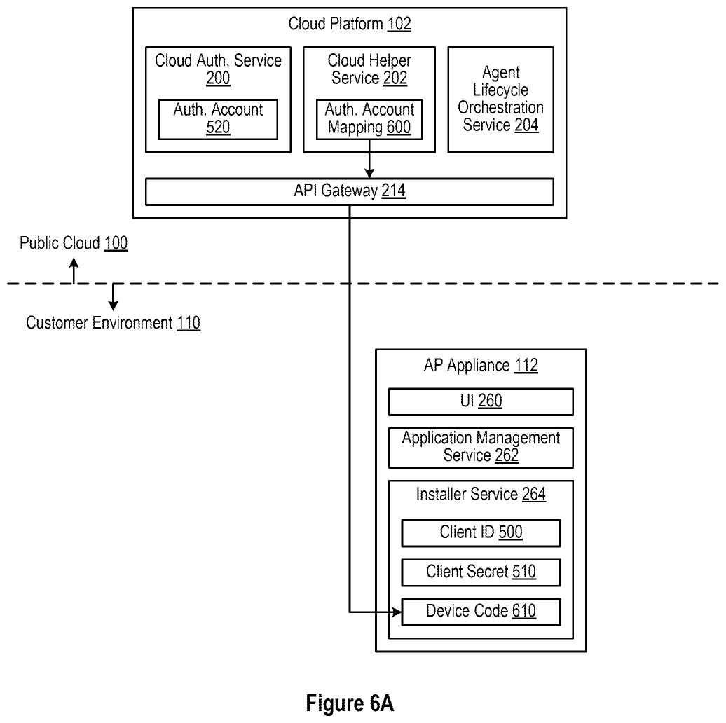

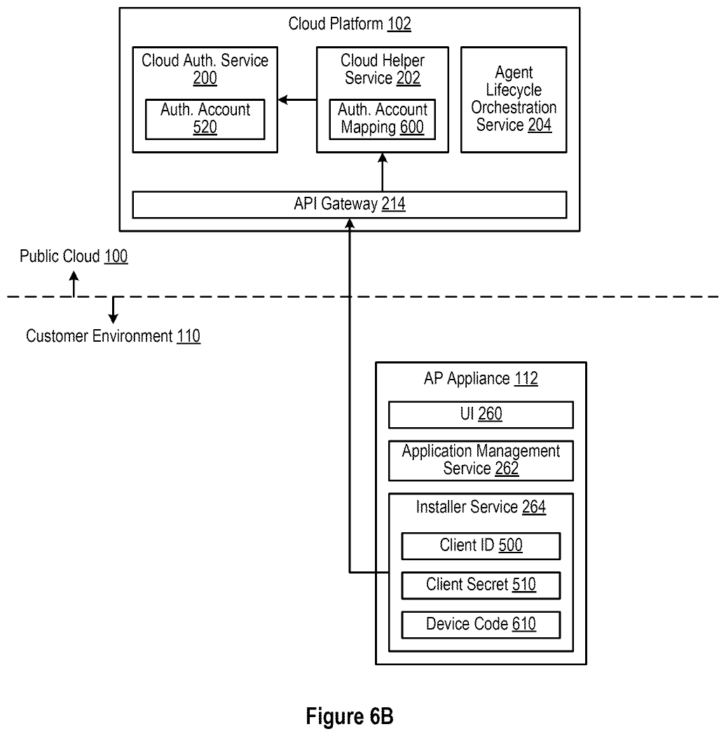

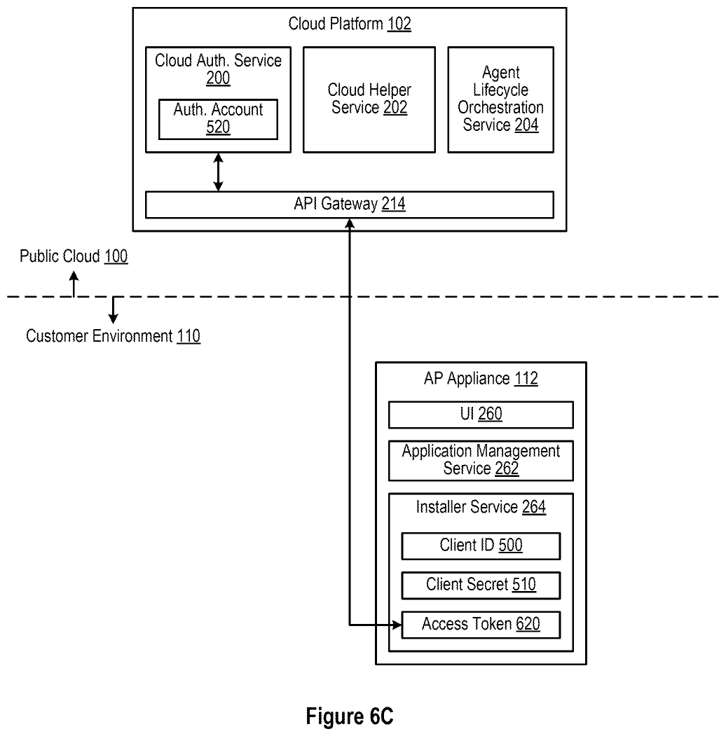

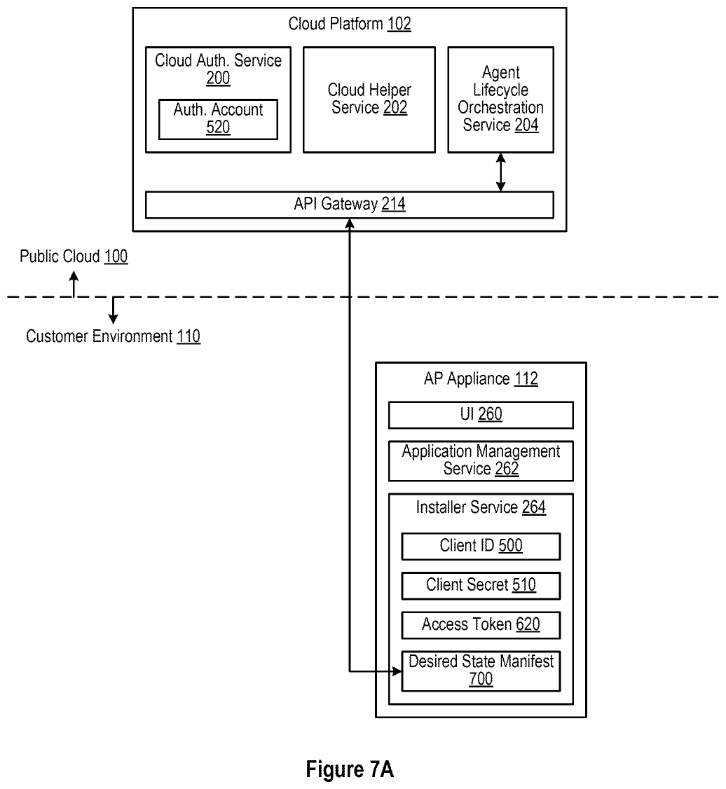

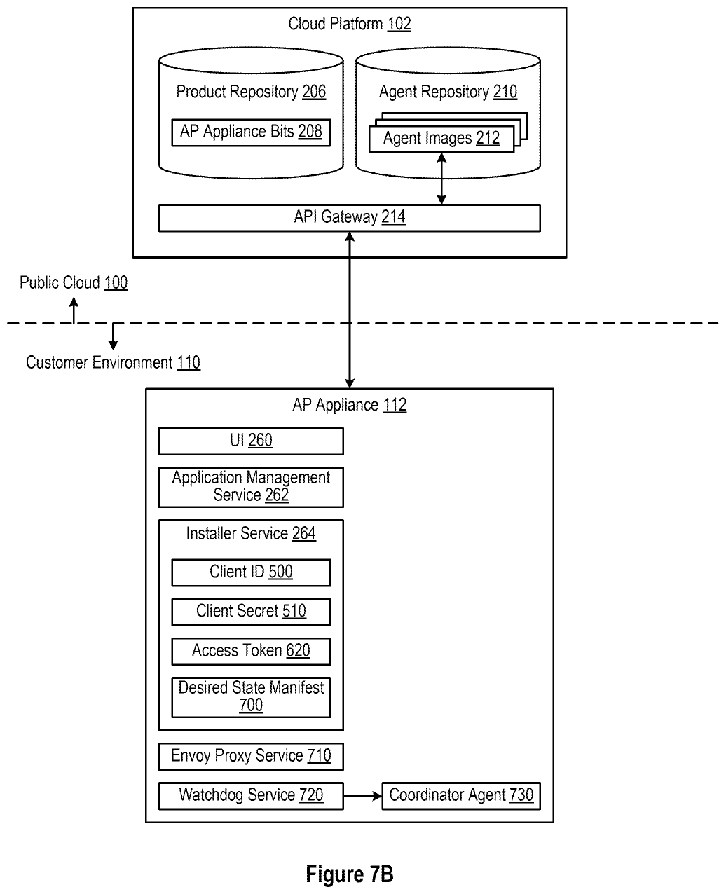

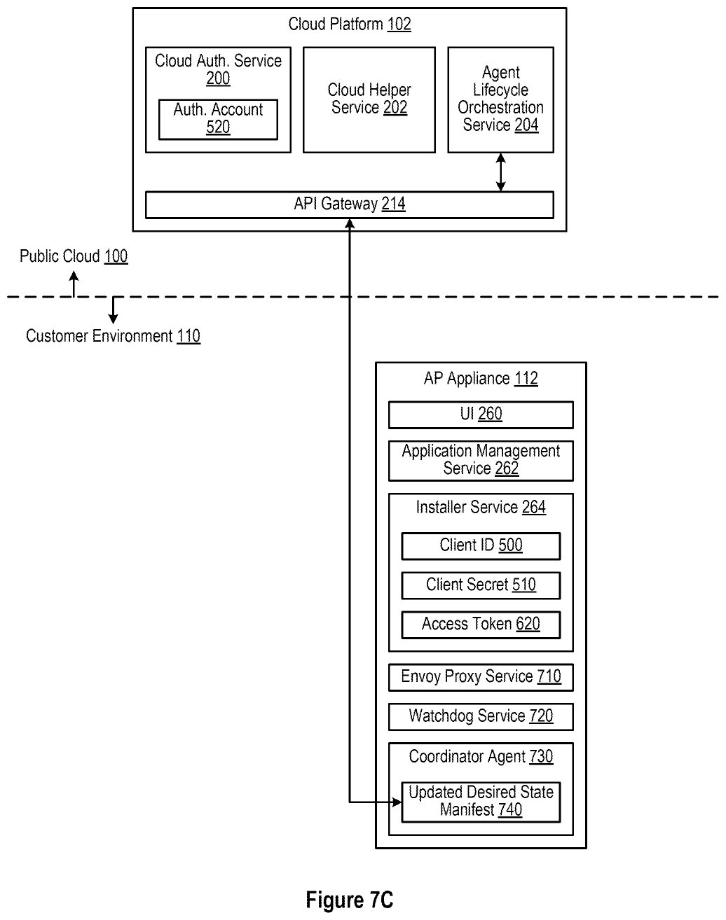

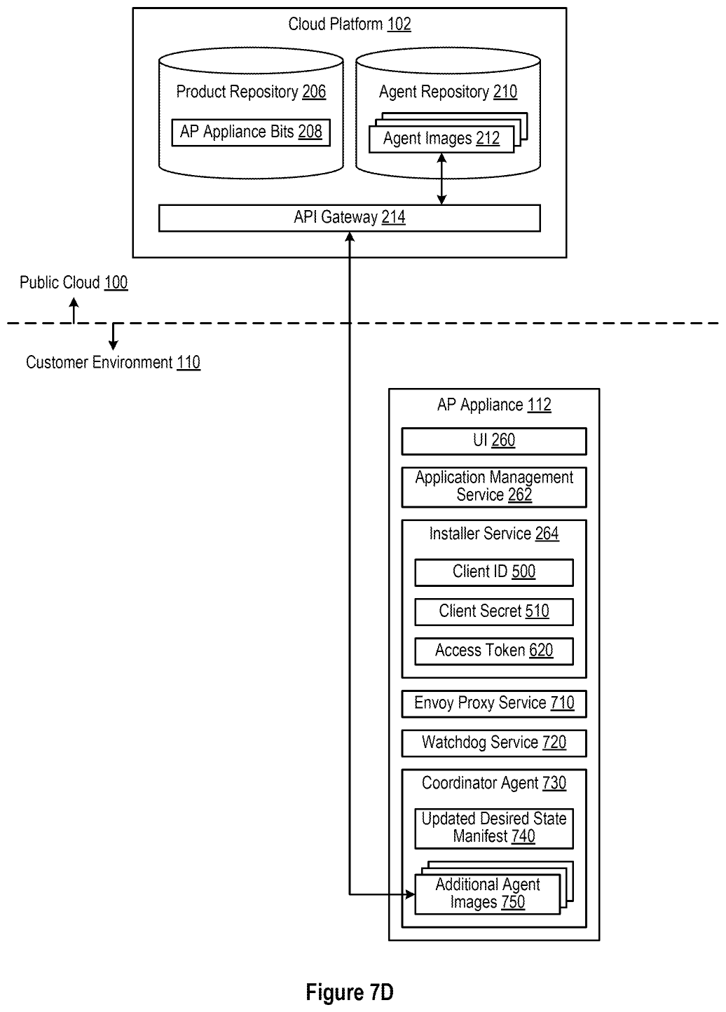

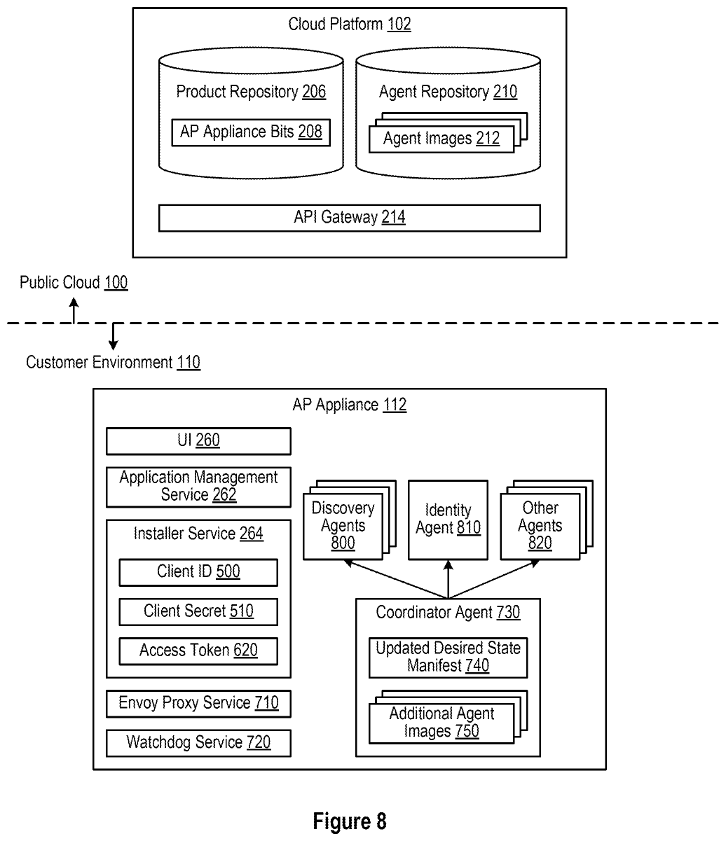

Next, installer service 264 executes steps 304 for deploying the AP before reaching a third checkpoint, “Registration of AP Appliance.” Steps 304 are discussed further below in conjunction with FIGS. 6A-6C. Next, installer service 264 executes steps 306 for deploying the AP before reaching a fourth checkpoint, “Downloading of Agents.” Steps 306 are discussed further below in conjunction with FIGS. 7A-7D. Finally, installer service 264 executes steps 308 for deploying the AP before reaching the end of the deployment. Steps 308 are discussed further below in conjunction with FIG. 8.

As discussed above, if installer service 264 encounters a recoverable error, installer service 264 resumes execution from a previous checkpoint. For example, if installer service 264 encounters a recoverable error while executing steps 308, installer service 264 may resume execution at the checkpoint “Downloading of Agents.” Furthermore, as discussed above, if installer service 264 encounters a nonrecoverable error, installer service 264 restarts the deployment of the AP (from “Start”). However, the downloading of AP appliance bits 208 and installing of AP appliance 112 are not repeated. It should be noted that the checkpoints illustrated in FIG. 3 are merely exemplary of checkpoints that may be used according to the teachings herein. Checkpoints at different points during the deployment of the AP may be used instead or in addition to the illustrated checkpoints.

FIG. 4 is a block diagram of customer environment 110 and public cloud 100, illustrating execution of steps 300 to reach the first checkpoint of the deployment of the AP. The first checkpoint, titled “Communication Checks,” is reached upon verifying that AP appliance 112 is able to communicate with cloud platform 102 with a latency that is below a threshold. Installer service 264 initiates a communication session with cloud platform 102, e.g., via API gateway 214. If cloud platform 102 responds with a latency that is below a threshold, then installer service 264 determines that communication between AP appliance 112 and cloud platform 102 is sufficient. Steps 300 are then complete and the first checkpoint, “Communication Checks,” is reached.

FIG. 5 is a block diagram of customer environment 110 and public cloud 100, illustrating execution of steps 302 to reach a second checkpoint of the deployment of the AP. The second checkpoint, which is titled “Creation of Authentication Account,” is reached upon creating an authentication account 520 to be used for acquiring access tokens for authenticating with cloud services. Installer service 264 generates a random client identifier (ID) 500 and a random client secret 510. Client ID 500 and client secret 510 are credentials for an authentication account to be created for AP appliance 112. Client ID 500 identifies AP appliance 112, and client secret 510 is a code associated with client ID 500.

Installer service 264 transmits client ID 500 and client secret 510 to cloud helper service 202, e.g., in an encrypted header of a message, via API gateway 214. Upon receiving client ID 500 and client secret 510, cloud helper service 202 requests cloud authentication service 200 to create authentication account 520 for AP appliance 112. Cloud authentication service 200 then creates authentication account 520 and uses client ID 500 and client secret 510 as credentials. Steps 302 are then complete and the second checkpoint, “Creation of Authentication Account,” is reached. It should be noted that at this point, AP appliance 112 has not yet registered with cloud platform 102. AP appliance 112 thus does not have permissions to acquire access tokens via authentication account 520.

FIGS. 6A-6C are a sequence of block diagrams of customer environment 110 and public cloud 100, illustrating execution of steps 304 to reach a third checkpoint of the deployment of the AP. The third checkpoint, which is titled “Registration of AP Appliance,” is reached upon registering AP appliance 112 with cloud platform 102 to enable AP appliance 112 to acquire the access tokens via authentication account 520. Registration of AP appliance 112 involves establishing trust between AP appliance 112 and cloud platform 102. Establishing such trust prevents authentication account 520 from being used fraudulently.

FIG. 6A illustrates a first portion of steps 304. Cloud helper service 202 generates a random device code 610 such as a six-digit number. Cloud helper service 202 then stores a mapping between device code 610, client ID 500, and client secret 510 in memory (not shown) of cloud helper service 202 as authentication account mapping 600. Cloud helper service 202 transmits device code 610 to installer service 264 to be stored thereby. It should be noted that device code 610 has a limited TTL after which device code 610 expires. Accordingly, to successfully establish trust with cloud platform 102, installer service 264 will transmit device code 610 back to cloud helper service 202 before the TTL expires, as discussed further below.

FIG. 6B illustrates a second portion of steps 304. AP appliance 112 transmits client ID 500, client secret 510, and device code 610 to cloud helper service 202 via API gateway 214. For example, installer service 264 may automatically transmit client ID 500, client secret 510, and device code 610 to cloud helper servicer 202. Alternatively, installer service 264 may transmit device code 610 to UI 260 to be displayed to the administrator. The administrator may then enter device code 610 via UI 260, at which point installer service 264 transmits client ID 500, client secret 510, and device code 610 to cloud helper service 202. In the case of the administrator entering device code 610, application management service 262 generates a session ID for installer service 264 to validate a session with UI 260.

Cloud helper service 202 compares the received client ID 500, client secret 510, and device code 610 to the information stored in authentication account mapping 600. If there is a match between each of the received client ID 500, client secret 510, and device code 610 to the information of authentication account mapping 600, and if device code 610 has not expired, cloud helper service 202 determines that it trusts AP appliance 112. This is because whichever entity transmitted device code 610 to cloud helper service 202 also possesses client ID 500 and client secret 510, which were transmitted to cloud helper service 202 earlier. Accordingly, if a fraud intercepted device code 610 from cloud helper service 202, that fraud would have also needed to possess client ID 500 and client secret 510.

Upon determining that AP appliance 112 is trusted, cloud helper service 202 requests cloud authentication service 200 to grant permissions to AP appliance 112. Such permissions include acquiring desired states from agent lifecycle orchestration service 204 and downloading images of agents from agent repository 210. For example, authentication account 520 may use a protocol such as OAuth 2.0.

FIG. 6C illustrates a third portion of steps 304. Installer service 264 transmits an API request to cloud authentication service 200 via API gateway 214 for an access token 620. The request includes client ID 500 and client secret 510 in an encrypted header of the request. Cloud authentication service 200 matches client ID 500 and client secret 510 to credentials of authentication account 520. Upon determining the match, cloud authentication service 200 transmits access token 620 to installer service 264 to be used thereby. Upon receiving access token 620, installer service 264 knows that AP appliance 112 is registered with cloud platform 102. Otherwise, upon requesting access token 620, access would be denied. Steps 304 are thus complete, and the third checkpoint, “Registration of AP Appliance,” is reached.

FIGS. 7A-7D are a sequence of block diagrams of customer environment 110 and public cloud 100, illustrating execution of steps 306 to reach a fourth checkpoint of the deployment of the AP. The fourth checkpoint, which is titled “Downloading of Agents,” is reached upon downloading agents to be installed on AP appliance 112.

FIG. 7A illustrates a first portion of steps 306. Installer service 264 transmits an API request to agent lifecycle orchestration service 204 via API gateway 214 for a desired state of AP appliance 112. The request includes access token 620. In response to the request and upon verifying permissions of access token 620, agent lifecycle orchestration service 204 transmits a desired state manifest 700 to installer service 264. Desired state manifest 700 includes a list of agents to install on AP appliance 112.

FIG. 7B illustrates a second portion of steps 306. Based on desired state manifest 700, installer service 264 determines to download an image of a coordinator agent 730. Installer service 264 transmits an API request to agent repository 210 for the image. The request includes access token 620. In response to the request and upon verifying permissions of access token 620, agent repository 210 transmits the image of coordinator agent 730 to installer service 264. Installer service 264 then installs and launches an envoy proxy service 710 and watchdog service 720. As discussed above, code for executing envoy proxy service 710 and watchdog service 720 was included in AP appliance bits 208. Envoy proxy service 710 is a service that forwards communications between services of AP appliance 112, between agents of AP appliance 112, and between services and agents.

Installer service 264 transmits the image of coordinator agent 730 to watchdog service 720 via envoy proxy service 710, and watchdog service 720 installs coordinator agent 730 from the image thereof. Coordinator agent 730 is a service that is responsible for installing other agents on AP appliance 112 and managing the lifecycle and orchestration thereof. After installing coordinator agent 730, watchdog service 720 continuously monitors coordinator agent 730. If coordinator agent 730 malfunctions, watchdog service 720 reinstalls coordinator agent 730 from an image thereof.

FIG. 7C illustrates a third portion of steps 306. Coordinator agent 730 transmits an API request to agent lifecycle orchestration service 204 via API gateway 214 for an updated desired state of AP appliance 112. The request includes access token 620. In response to the request and upon verifying permissions of access token 620, agent lifecycle orchestration service 204 transmits an updated desired state manifest 740 to coordinator agent 730. Updated desired state manifest 740 includes a list of agents to install on AP appliance 112.

FIG. 7D illustrates a fourth portion of steps 306. Based on updated desired state manifest 740, coordinator agent 730 determines to download additional images of agents. Coordinator agent 730 transmits an API request to agent repository 210 for the images. The request includes access token 620. In response to the request and upon verifying permissions of access token 620, agent repository 210 transmits additional agent images 750 to coordinator agent 730. Steps 306 are then complete, and the fourth checkpoint, “Downloading of Agents,” is reached.

FIG. 8 is a block diagram of customer environment 110 and public cloud 100, illustrating execution of steps 308 to complete the deployment of the AP. The deployment is complete when all the agents listed in updated desired state manifest 740 have been successfully installed on AP appliance 112. Using additional agent images 750, coordinator agent 730 installs discovery agents 800, an identity agent 810, and other agents 820. Discovery agents 800 manage communications with respective management appliances of SDDC 114-1. One of discovery agents 800 manages communications with VIM server appliance 250 for all of SDDCs 114, and others of discovery agents 800 manage communications with others of management appliances 116 of SDDCs 114. To manage such communications, discovery agents 800 store administrative credentials of respective management appliances for logging in to the respective management appliances and performing administrative operations.

Identity agent 810 acquires access tokens from cloud authentication service 200 on behalf of other agents 820. Accordingly, identity agent 810 is given access to client ID 500 and client secret 510, which identity agent 810 includes in requests to cloud authentication service 200 for access tokens. As discussed earlier, each access token has a specified TTL after which it expires. Accordingly, to continue enabling communications between agents and cloud services, identity agent 810 occasionally requests a new access token. Other agents 820 correspond to cloud services of cloud platform 102 such as the SDDC configuration service, the SDDC upgrade service, the SDDC monitoring service, and the SDDC inventory service. Other agents 820 issue commands to management appliances 116 and report results of operations to respective cloud services via API gateway 214.

Installer service 264 then generates and stores credentials for a root user account (not shown) of AP appliance 112. The root user account is associated with permissions such as to create temporary accounts that further permit performing operations on management appliances such as VIM server appliance 250. The root user credentials are accessible to identity agent 810, and identity agent 810 accesses the root user account to create such temporary accounts for other agents installed on AP appliance 112. The other agents use such local accounts to perform operations on the management appliances. Furthermore, identity agent 810, which has access to client secret 510 and a password of the root user account, periodically changes client secret 510 and the password of the root user account for security purposes. In one embodiment, each of the agents installed on AP appliance 112 is a microservice that is implemented as one or more container images executing in AP appliance 112. After the installation of the additional agents, steps 308, and by extension, the deployment of the AP on AP appliance 112, are complete.

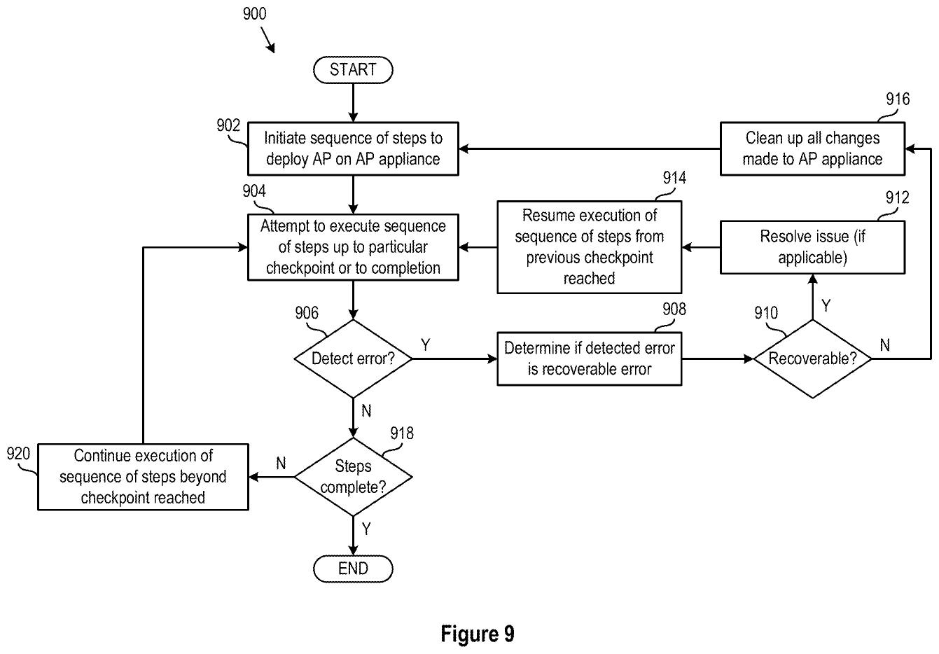

FIG. 9 is a flow diagram of a method 900 performed by installer service 264 to execute a sequence of steps to deploy the AP on AP appliance 112, according to an embodiment.

Method 900 begins after AP appliance 112 is installed from AP appliance bits 208. At step 902, installer service 264 initiates the sequence of steps to deploy the AP. At step 904, installer service 264 attempts to execute the sequence of steps up to a particular checkpoint or, if installer service 264 has already reached the last checkpoint, to completion of the deployment. For example, if installer service 264 has not reached any checkpoints yet, the particular checkpoint is “Communication Checks.” If installer service 264 has already reached the checkpoint “Downloading of Agents,” installer service 264 attempts to execute the sequence of steps to completion of the deployment.

At step 906, if installer service 264 detects an error in executing the sequence of steps, method 900 moves to step 908. At step 908, installer service 264 determines if the detected error is a recoverable error. For example, installer service 264 may maintain a list of error codes that correspond to recoverable errors. If the detected error has an error code that is included in the list, then installer service 264 determines that the detected error is a recoverable error. For example, nonrecoverable errors include a service on AP appliance 112 crashing such as envoy proxy service 710 or watchdog service 720, failure for installer service 264 to generate client ID 500 and/or client secret 510, and failure for installer service 264 or coordinator agent 730 to download a desired state from agent lifecycle orchestration service 204.

Several examples of recoverable errors will now be discussed. A first recoverable error is a network connection between AP appliance 112 and cloud platform 102 being down. A second recoverable error is a cloud service of cloud platform 102 being down. A third recoverable error is a maximum number of authentication accounts having been reached for the administrator. A fourth recoverable error is an issue with downloading an agent image from agent repository 210, which may be caused by the agent image being corrupted, there being a broken link to agent repository 210, or agent repository 210 being down.

A fifth recoverable error is an issue with the administrator selecting an account on cloud platform 102 when registering AP appliance 112 with cloud platform 102. Such a recoverable error may be encountered upon the administrator entering incorrect credentials for accessing the account or the administrator selecting one account during the deployment and later selecting a different account. A sixth recoverable error is an issue with obtaining device code 610 from cloud helper service 202. Such a recoverable error may be encountered because installer service 264 never receives device code 610, because installer service 264 errantly requests multiple device codes and does not know which to use, or because installer service 264 does not receive a response from cloud helper service 202 when transmitting client ID 500, client secret 510, and device code 610 to cloud helper service 202.

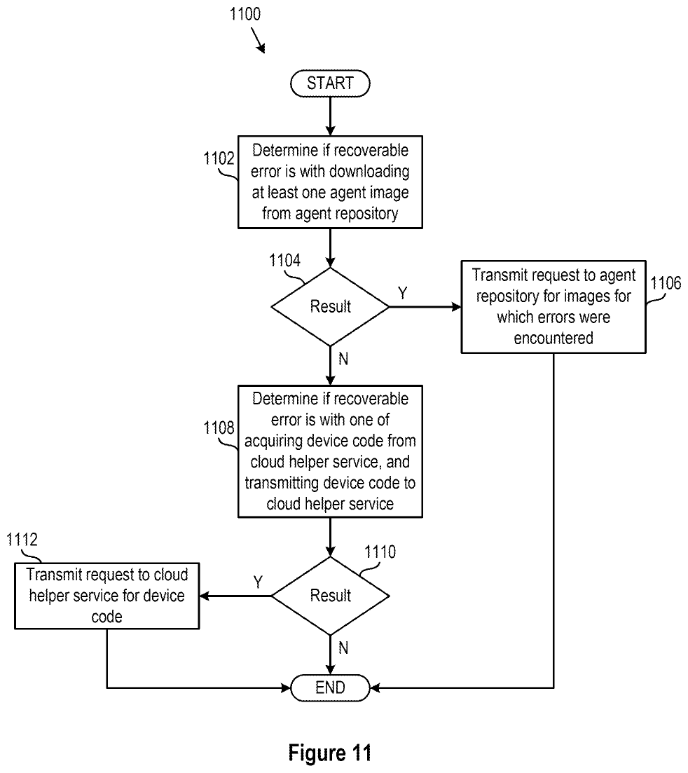

At step 910, if the detected error is a recoverable error, method 900 moves to step 912. At step 912, if applicable, the issue that caused the recoverable error is resolved. For example, for a down network connection, the network connection may be restarted. For a down cloud service, the cloud service may be restarted. If the maximum number of authentication accounts has been reached, the administrator may designate a larger maximum number or select one or more preexisting authentication accounts to be deleted. If agent repository 210 is down, agent repository 210 may be restarted. For some recoverable errors, the issue may be resolved upon resuming execution of the sequence of steps, as discussed further below in conjunction with FIG. 11.

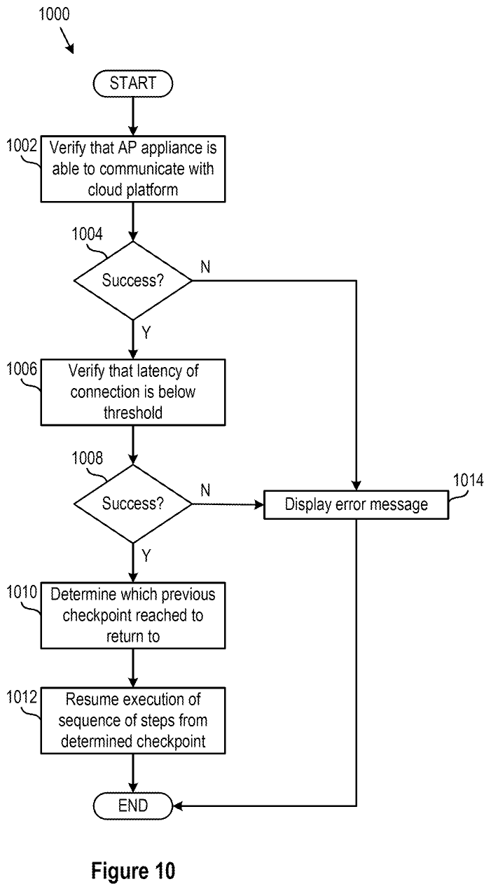

At step 914, installer service 264 resumes execution of the sequence of steps from a previous checkpoint reached. For example, if installer service 264 was currently executing steps 304, installer service 264 may return to the checkpoint: “Creation of Authentication Account.” Step 914 will be discussed further below in conjunction with FIG. 10. After step 914, method 900 returns to step 904, and installer service 264 attempts to execute the sequence of steps starting at the checkpoint returned to at step 914.

Returning to step 910, if the detected error is a nonrecoverable error, method 900 moves to step 916. At step 916, installer service 264 cleans up all changes made to AP appliance 112 since initiating the sequence of steps at step 902. For example, if installer service 264 generated client ID 500 and client secret 510, installer service 264 deletes client ID 500 and client secret 510. After step 916, method 900 returns to step 902, and installer service 264 again initiates a sequence of steps to deploy the AP on AP appliance 112.

Returning to step 906, if installer service 264 does not detect an error, method 900 moves to step 918. At step 918, if the sequence of steps is not yet complete, method 900 moves to step 920. At step 920, installer service 264 continues execution of the sequence of steps beyond the last checkpoint reached, and method 900 returns to step 904. Otherwise, at step 918, if the sequence of steps is complete, method 900 ends.

FIG. 10 is a flow diagram of a method 1000 performed by installer service 264 upon encountering a recoverable error, to resume execution of the sequence of steps from a previous checkpoint that was reached. At step 1002, installer service 264 verifies that AP appliance 112 is able to communicate with cloud platform 102. For example, installer service 264 may transmit a message to API gateway 214. If installer service 264 receives a response, installer service 264 determines that AP appliance 112 is able to communicate with cloud platform 102. Otherwise, if installer service 264 does not receive a response, installer service 264 determines that AP appliance 112 is not able to communicate with cloud platform 102.

At step 1004, if installer service 264 determines that AP appliance 112 is unable to communicate with cloud platform 102, method 1000 moves to step 1014. Otherwise, if installer service 264 determines that AP appliance 112 can communicate with cloud platform 102, method 1000 moves to step 1006. At step 1006, installer service 264 verifies that the latency of its connection with cloud platform 102 is below a threshold. At step 1008, if the latency is not below the threshold, method 1000 moves to step 1014. Otherwise, if the latency is below the threshold, method 1000 moves to step 1010.

At step 1010, installer service 264 determines which previous checkpoint reached to return to. One approach is to return to the most recent checkpoint reached. However, rules may also be defined for returning to other checkpoints based on predetermined factors. If installer service 264 has not yet reached a checkpoint, the sequence of steps to deploy the AP is restarted. At step 1012, installer service 264 resumes execution of the sequence of steps, from the checkpoint determined at step 1010 (or from the beginning, if applicable). After step 1012, method 1000 ends.

Returning to step 1014, if installer service 264 is unable to verify that AP appliance 112 can communicate with cloud platform 102 or that the latency of such communication is below the threshold, installer service 264 displays an error message to the administrator accordingly via UI 260. After step 1014, method 1000 ends, and an issue regarding the network connection is resolved before execution of the sequence of steps is resumed.

FIG. 11 is a flow diagram of a method 1100 performed by installer service 264 to resolve an issue that caused a recoverable error upon resuming execution of the sequence of steps to deploy the AP on AP appliance 112. At step 1102, installer service 264 determines if the recoverable error is with downloading at least one agent image from agent repository 210. At step 1104, if the recoverable error is with downloading at least one agent image, method 1100 moves to step 1106.

At step 1106, installer service 264 transmits a request to agent repository 210 for the one or more images that failed to download. Installer service 264 does not redownload any images that were already successfully downloaded. After step 1106, method 1100 ends, and installer service 264 continues executing the sequence of steps to deploy the AP. Returning to step 1104, if the recoverable error is not with downloading at least one image, method 1100 moves to step 1108.

At step 1108, installer service 264 determines if the recoverable error is with one of acquiring device code 610 from cloud helper service 202, and transmitting device code 610 to cloud helper service 202 (along with client ID 500 and client secret 510). At step 1110, if the recoverable error is with one of acquiring and transmitting device code 610, method 1100 moves to step 1112. At step 1112, installer service 264 transmits a request to cloud helper service 202 for a device code. After step 1112, method 1100 ends, and installer service 264 continues executing the sequence of steps to deploy the AP. Returning to step 1110, if the recoverable error is not with one of acquiring and transmitting device code 610, method 1100 ends, and installer service 264 continues executing the sequence of steps to deploy the AP.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of deploying an agent platform on an agent platform appliance, wherein the agent platform connects management appliances to cloud services executing on a cloud platform, the method comprising:
initiating a sequence of steps to deploy the agent platform on the agent platform appliance;
executing the sequence of steps up to a particular checkpoint, and continuing execution of the sequence of steps beyond the particular checkpoint;
during the continued execution of the sequence of steps beyond the particular checkpoint, detecting an error;
determining that the detected error is a recoverable error; and
in response to the determining that the detected error is a recoverable error, resuming execution of the sequence of steps from the particular checkpoint.

2. The method of claim 1, wherein the particular checkpoint is one of a plurality of checkpoints, which are reached upon:
(1) verifying that the agent platform appliance is able to communicate with the cloud platform with a latency that is below a threshold,
(2) creating an authentication account to be used for acquiring access tokens for authenticating with the cloud services,
(3) registering the agent platform appliance with the cloud platform to enable the agent platform appliance to acquire the access tokens via the authentication account, and
(4) downloading agents to be installed on the agent platform appliance.

3. The method of claim 1, further comprising:
upon the resuming of execution of the sequence of steps from the particular checkpoint, verifying that the agent platform appliance is able to communicate with the cloud platform with a latency that is below a threshold.

4. The method of claim 1, wherein the sequence of steps includes transmitting a first request to the cloud platform for images of agents, and the detected error is an error with downloading at least one of the images of the agents.

5. The method of claim 4, further comprising:
upon the resuming of execution of the sequence of steps from the particular checkpoint, transmitting a second request to the cloud platform for the at least one of the images of the agents.

6. The method of claim 1, wherein the sequence of steps includes transmitting a first request to the cloud platform for a code to be used for registering the agent platform appliance with the cloud platform and includes transmitting the code to the cloud platform, and the detected error is an error with either acquiring the code from the cloud platform or transmitting the code to the cloud platform.

7. The method of claim 6, further comprising:
upon the resuming of execution of the sequence of steps from the particular checkpoint, transmitting a second request to the cloud platform for another code to be used for registering the agent platform appliance with the cloud platform.

8. A non-transitory computer-readable medium comprising instructions that are executable in a computer system, wherein the instructions when executed cause the computer system to carry out a method of deploying an agent platform on an agent platform appliance, and wherein the agent platform connects management appliances to cloud services executing on a cloud platform, the method comprising:
initiating a sequence of steps to deploy the agent platform on the agent platform appliance;
executing the sequence of steps up to a particular checkpoint, and continuing execution of the sequence of steps beyond the particular checkpoint;
during the continued execution of the sequence of steps beyond the particular checkpoint, detecting an error;
determining that the detected error is a recoverable error; and
in response to the determining that the detected error is a recoverable error, resuming execution of the sequence of steps from the particular checkpoint.

9. The non-transitory computer-readable medium of claim 8, wherein the particular checkpoint is one of a plurality of checkpoints, which are reached upon:
(1) verifying that the agent platform appliance is able to communicate with the cloud platform with a latency that is below a threshold,
(2) creating an authentication account to be used for acquiring access tokens for authenticating with the cloud services,
(3) registering the agent platform appliance with the cloud platform to enable the agent platform appliance to acquire the access tokens via the authentication account, and
(4) downloading agents to be installed on the agent platform appliance.

10. The non-transitory computer-readable medium of claim 8, the method further comprising:
upon the resuming of execution of the sequence of steps from the particular checkpoint, verifying that the agent platform appliance is able to communicate with the cloud platform with a latency that is below a threshold.

11. The non-transitory computer-readable medium of claim 8, wherein the sequence of steps includes transmitting a first request to the cloud platform for images of agents, and the detected error is an error with downloading at least one of the images of the agents.

12. The non-transitory computer-readable medium of claim 11, the method further comprising:
upon the resuming of execution of the sequence of steps from the particular checkpoint, transmitting a second request to the cloud platform for the at least one of the images of the agents.

13. The non-transitory computer-readable medium of claim 8, wherein the sequence of steps includes transmitting a first request to the cloud platform for a code to be used for registering the agent platform appliance with the cloud platform and includes transmitting the code to the cloud platform, and the detected error is an error with either acquiring the code from the cloud platform or transmitting the code to the cloud platform.

14. The non-transitory computer-readable medium of claim 13, the method further comprising:
upon the resuming of execution of the sequence of steps from the particular checkpoint, transmitting a second request to the cloud platform for another code to be used for registering the agent platform appliance with the cloud platform.

15. A computer system comprising a plurality of host servers, wherein the plurality of host servers includes an agent platform appliance that connects management appliances to cloud services executing on a cloud platform, and the agent platform appliance is configured to:
initiate a sequence of steps to deploy an agent platform on the agent platform appliance;
execute the sequence of steps up to a particular checkpoint, and continue execution of the sequence of steps beyond the particular checkpoint;
during the continued execution of the sequence of steps beyond the particular checkpoint, detect an error;
determine that the detected error is a recoverable error; and
in response to the determining that the detected error is a recoverable error, resume execution of the sequence of steps from the particular checkpoint.

16. The computer system of claim 15, wherein the particular checkpoint is one of a plurality of checkpoints, which are reached upon:
(1) verifying that the agent platform appliance is able to communicate with the cloud platform with a latency that is below a threshold,
(2) creating an authentication account to be used for acquiring access tokens for authenticating with the cloud services,
(3) registering the agent platform appliance with the cloud platform to enable the agent platform appliance to acquire the access tokens via the authentication account, and
(4) downloading agents to be installed on the agent platform appliance.

17. The computer system of claim 15, wherein the agent platform appliance is further configured to:
upon the resuming of execution of the sequence of steps from the particular checkpoint, verify that the agent platform appliance is able to communicate with the cloud platform with a latency that is below a threshold.

18. The computer system of claim 15, wherein the sequence of steps includes transmitting a first request to the cloud platform for images of agents, and the detected error is an error with downloading at least one of the images of the agents.

19. The computer system of claim 18, wherein the agent platform appliance is further configured to:
upon the resuming of execution of the sequence of steps from the particular checkpoint, transmit a second request to the cloud platform for the at least one of the images of the agents.

20. The computer system of claim 15,
wherein the sequence of steps includes transmitting a first request to the cloud platform for a code to be used for registering the agent platform appliance with the cloud platform and includes transmitting the code to the cloud platform, and the detected error is an error with either acquiring the code from the cloud platform or transmitting the code to the cloud platform, and
wherein the agent platform appliance is further configured to:
upon the resuming of execution of the sequence of steps from the particular checkpoint, transmit a second request to the cloud platform for another code to be used for registering the agent platform appliance with the cloud platform.
